(19) United States
(12) Patent Application Publication
(10) Pub. No.: US 2019/0134807 A1
(43) Pub. Date: May 9, 2019

(54) METAL MARKER FOR CORRUGATED STEEL

(71) Applicants: Will Buster, Morning Sun, IA (US); DREW BUSTER, Morning Sun, IA (US)

(72) Inventors: Will Buster, Morning Sun, IA (US); DREW BUSTER, Morning Sun, IA (US)

(21) Appl. No.: 15/807,641

(22) Filed: Nov. 9, 2017

(51) Int. Cl. B25H 7/02

(52) U.S. Cl. CPC B25H 7/02

(57) ABSTRACT

A metal marker that includes: a flat top surface; an arm attached to at least one side of the metal marker; and a plurality of notches on a bottom surface of the marker, where the plurality of notches is adapted for placement over corrugated steel. The arm pivotally extends from the marker and provides a means for marking angles on corrugated steel. The top surface preferably includes a ruler and a level to aid in the marking of the underlying corrugated steel.

### BACKGROUND OF THE INVENTION

### Field of Invention

The present invention is a metal marking device that is used to mark corrugated steel.

### Description of Related Art

Installing sheets of corrugated metal can be a complicated process. There is no easy way to mark corrugated steel accurately when placing screws or cutting it, and leveling is always an issue when installing the sheets vertically, as the level must be held just right. It is a time- consuming task to find the angle needed when installing sheets in a valley or over a hip. Many contractors will use a piece of cut-off metal for making horizontal marks, once they figured out the correct angle. However, when roofing an older house, the valleys may not be true. It is also cumbersome to use a cut-off piece of metal and difficult to keep it from scratching the new metal. Even when a contractor uses a sheet rock square and is careful when making the marks, the result is never very accurate. The object of the present invention is to provide a tool that will allow contractors to mark corrugated metal with greater accuracy when it is being installed on roof or vertically on sidewalls, and it will make finding and marking the angles accurately easier as well.

### SUMMARY OF THE INVENTION

The present invention relates to a metal marker that includes: a flat top surface; an arm attached to at least one side of the metal marker; and a plurality of notches on a bottom surface of the marker, where the plurality of notches is adapted for placement over corrugated steel. The arm pivotally extends from the marker and provides a means for marking angles on corrugated steel. The top surface preferably includes a ruler and a level to aid in the marking of the underlying corrugated steel.

The present invention provides the following benefits for corrugated sheet metal installers everywhere:
A new tool designed to fit across the profile of the sheet metal
This tool will make it easier and faster to mark the metal accurately as it sits flat when laid across the sheet
Horizontal marks needed for cutting and screwing can be placed more accurately when this tool is used
The indentations every 1/8th of an inch make it easy to use a pencil for marking the metal
The tool slides easily down the sheet to make the accurate marks needed when cutting out for openings or ripping the sheet completely
The side arms can be used to find the angles of valleys, hips and gable ends without needing a tape measurer, and they can then be transferred easily to the metal for marking
The embedded level makes it easy to install sheets accurately when they are installed vertically on sidewalls
Will be easy to use by professional contractors as well as those who are new to the field, and it will make their work easier, faster and more accurate

### BRIEF DESCRIPTION OF DRAWINGS

FIG. 1 depicts a first perspective view of a metal marker in accordance with the present invention.

FIG. 2 depicts a second perspective view of the metal marker in accordance with the present invention.

FIG. 3 depicts the top view of the metal marker according to the present invention.

### DETAILED DESCRIPTION

The metal marker according to the present invention is preferably used to make it easier to mark and efficiently install metal sheets. The metal marker is designed to fit corrugated metal commonly used in construction, which has ¾″ ribs every nine inches and with two smaller ribs (⅛″) between the nine-inch ribs. Preferably, the present invention is 38″ long, where the underside includes notches to accommodate the ribs, so the marker lies flat when laid horizontally across a sheet of corrugated metal. The top surface of the marker is flat with a ruler along one edge thereof. Small indentations may be provided at ⅛″, ¼″, ⅜″, ½″, ⅝″, ¾″, ⅞″, 1″ and so on. These indentations are big enough to be marked with a sharp lead pencil, so the steel may be measured and marked accurately. The present invention slides down the sheet to make the additional marks needed when cutting out an opening or ripping the sheet completely. The tool may have one or two arms, which pivot away from the marker for marking angles. Each arm includes a slide bar, so a user can adjust the length of the angle. The angle can then be locked in by tightening a fastener to keep the angle true when it is transferred to the metal for marking and cutting. The arms will also be useful when marking sheets for screws, to set the spacing when they are marked horizontally. The built-in level on the top allows a user to level the sheets when they are installed vertically. Alternate versions of the tool may be needed when installing corrugated sheet metal with different profiles, which may be used in some parts of the United States and other countries. Commercial steel installers usually predrill their steel, so a more useful version for them would have pilot holes for predrilling, notches, and a straight side for horizontal marking. This version would be slimmer and would not include the side angle finders. A different version of this tool can be designed for those installing SL-16 Standing Seam Steel. This would be a very simple jig with two angle—finder arms, notches and a straight side for marking.

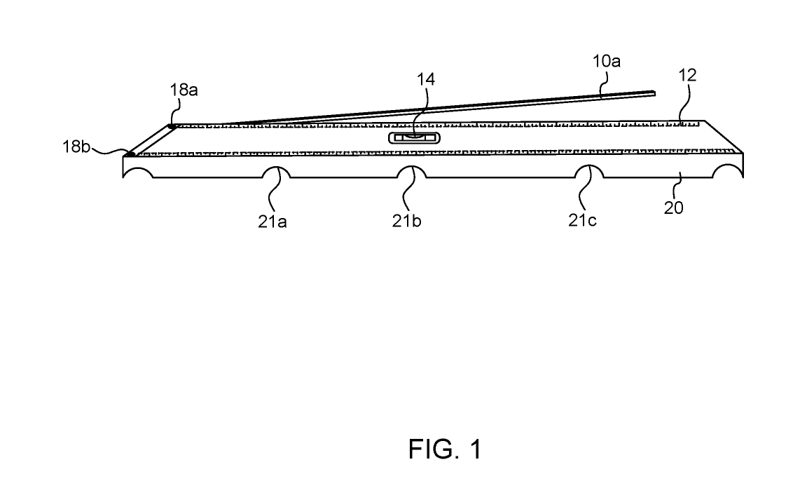

In reference to FIG. 1, a perspective view of a Metal Marker 100 is depicted. The Metal Marker 100 includes a Top Surface 12 as shown in FIG. 1. Other features of the Top Surface 12 include a Level 14 at the center of the Top Surface 12 and a Ruler 16 along both sides of the Top Surface 12. The bottom surface is adapted for placement over corrugated steel as provided by Notches 21a, 21b, 21c. These notches 21a, 21b, 21c are adapted to receive the corrugated steel. As a result, the Metal Marker 100 is placed over corrugated steel and then the marker is used to mark the steel for cutting and construction purposes. Additional features of the Metal Marker 100 include an Arm 10 pivotally attached to one side of the Metal Marker 100. This Arm 10 extends in length in addition to pivotally extending from the Metal Marker 100. The present invention allows a user to mark angles associated with fabrication of the underlying corrugated steel. A Fasteners 18a, 18b are shown that holds the arms in place and allow for the pivot and movement of Arms 10a, 10b.

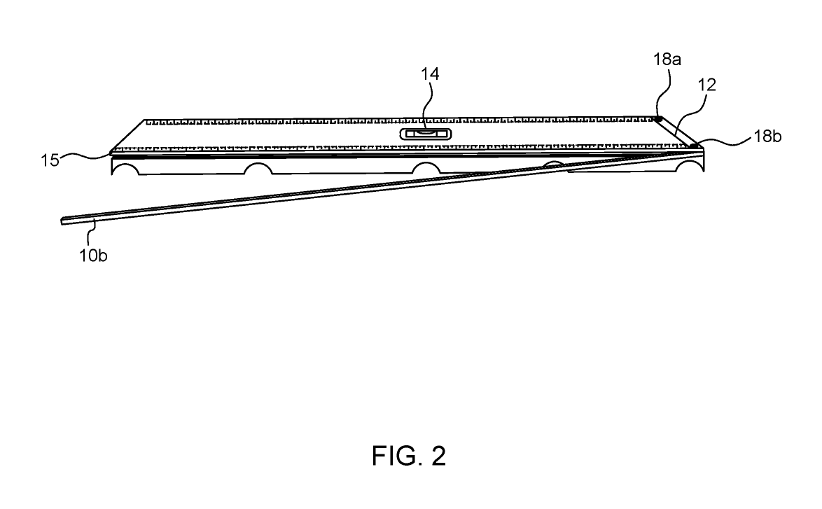

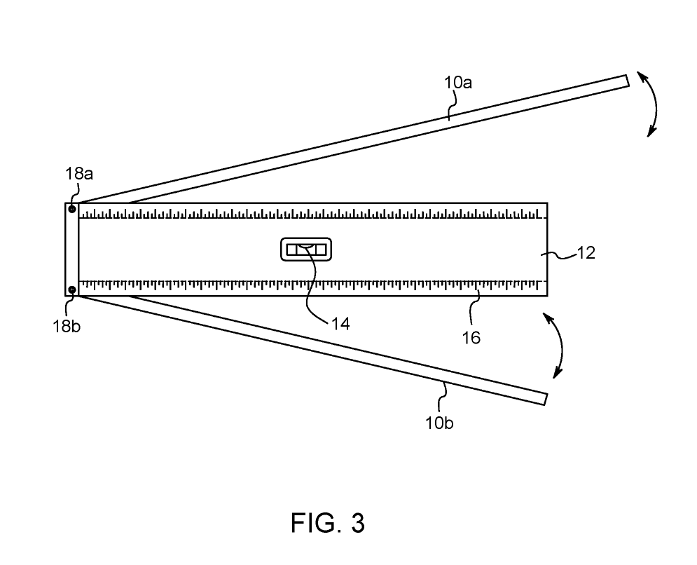

FIG. 2 shows a reverse perspective view of the Metal Marker 100 showing the Arm 10 again pivoting away from the Metal Marker 100. FIG. 3 shows a top view where the Ruler 16 is clearly marked along one side of the Metal Marker 100. The level 14 is also shown at the center of the top surface to provide a leveling feature associated with the Metal Marker 100. Metal Marker 100 is particularly adapted for placement over corrugated steel, where the Notches 21a, 21b, 21c are adapted to accommodate ribs associated with corrugated steel. Once placed over corrugated steel a user may easily mark the steel as needed based upon measurements, desired angles and so forth.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A metal marker comprising:
a. a flat top surface;
b. an arm attached to at least one side of the metal marker; and
c. a plurality of notches on a bottom surface of the marker, where the plurality of notches are adapted for placement over corrugated steel.

2. The metal marker according to claim 1, where the arm pivotally extends from the marker and provides a means for marking angles on corrugated steel.

3. The metal marker according to claim 1, where the top surface includes a ruler.

4. The metal marker according to claim 1, further including a level on the top surface.
